(19) United States
(12) Patent Application Publication
(10) Pub. No.: US 2024/0264732 A1
(43) Pub. Date: Aug. 8, 2024

(54) NON-LINEAR SCROLLING FOR USER INTERFACES

(71) Applicant: Microsoft Technology Licensing, LLC, Redmond, WA (US)

(72) Inventors: Adithya Jayan, Bengaluru (IN); Nishtha Pangle, Bengaluru (IN); Ajay Prasad, Bengaluru (IN); Neel Kamal Joshi, Elizabeth Bay (AU)

(21) Appl. No.: 18/564,835

(22) PCT Filed: May 20, 2022
(86) PCT No.: PCT/US2022/030152

§ 371 Date: Nov. 28, 2023

(30) Foreign Application Priority Data
Jun. 25, 2021 (IN) 202141028617

(51) Int. Cl. G06F 3/0485; G06F 3/0482

(52) U.S. Cl. CPC G06F 3/0485; G06F 3/0482

(57) ABSTRACT

Techniques for efficiently using a display area of a hardware display for a user interface are provided herein. Data items are displayed on the user interface at varying sizes based on a focal parameter value, such as a focal time. When the focal parameter value changes due to a scroll input or other input, the size and position of the data items is adjusted based on the updated focal parameter value such that a user is able to scroll through the data items in a non-linear fashion.

### TECHNICAL FIELD

This document pertains generally, but not by way of limitation, to user interfaces, and particularly but not by way of limitation, to non-linear scrolling of data items in a user interface for efficient use of a hardware display.

### BACKGROUND

Various applications provide a user interface scrollable to view data. For example, calendar applications are used for organizing schedules and accessing meeting data for respective users. Conventional calendar and other applications allow a user to scroll through data, such as scheduled events in the past or future. For computing devices with displays of limited size, displaying a large number of data items and enabling a user to navigate through those data items can be difficult.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1 is a network diagram illustrating several computing devices configured to access calendar data.

FIGS. 2A-2D are diagrams illustrating an example user interface for non-linear scrolling of data.

FIG. 3 is a diagram illustrating another example user interface for non-linear scrolling of data.

FIG. 4 is a diagram illustrating another example user interface for non-linear scrolling of data.

FIG. 5 is a flowchart illustrating an example method of providing non-linear scrolling for a calendar application.

FIG. 6 is a block diagram illustrating an example of a machine upon which one or more embodiments may be implemented.

### DETAILED DESCRIPTION

Systems and methods are disclosed herein for providing a user interface that facilitates efficient use of a display space for a hardware display and provides efficient scrolling across a large range of data while simultaneously maintaining visibility of detailed granularity of the data. Efficient scrolling is achieved using non-linear scrolling based on received scroll inputs.

The term ‘non-linear scrolling’ is used herein to refer to the fact that, unlike conventional linear scrolling, there is not a linear or uniform change to the data items displayed on the user interface in response to a scroll input. The non-linear scrolling may be implemented in a number of different ways and various examples are described below. Any combination of these may be implemented together to further accentuate the non-linear response to a scroll input.

Data items are grouped and ordered according to each data item's respective value of a reference parameter. The reference parameter may be a time, such that the data items are ordered chronologically, with the reference parameter for a data item corresponding to a scheduled time for a calendar event or the edit or creation time for files (e.g. documents, spreadsheets, etc.). The reference parameter for a data item is a property of the data item. Data items are selected for display based on their reference parameter values and a user may navigate through the data items by adjusting a focal value of the reference parameter, such as a selected time for a calendar interface, and the focal value is changed by providing a scroll input.

In addition to the focal value of the reference parameter that is updated in response to a scroll input, a baseline value of the reference parameter may also be defined and the baseline value is not updated in response to a scroll input. The baseline value of the reference parameter may be fixed or may be updated based on other criteria. For example, where the reference parameter is a time (e.g. scheduled time, edit time or creation time), the baseline value of the reference parameter may correspond to the current time and its value will be updated as time progresses (e.g. continuously or periodically, such as every minute, every hour or every day).

As described above, the data items are grouped according to their respective value of the reference parameter. A plurality of ranges of reference parameter values are defined, one for each group, and each group of data items comprises those data items that have a reference parameter value that falls within the corresponding range of reference parameter values. The ranges of reference parameter values (that define the groups) are non-overlapping. The ranges may not all be of equal size (i.e. the ranges may comprise ranges of different sizes) and the ranges may depend upon various factors, such as the number of data items and the spread of data items relative to the reference parameter. The defined ranges may be contiguous (such that the focal value always overlaps with one of the ranges) or there may be gaps between the ranges. The ranges of reference parameters (and hence groups) may comprise at least one range close to the baseline value and that is defined relative to the baseline value (e.g. ‘next hour’ or ‘later today’ for data items arranged chronologically) and at least one range that is defined in absolute terms (e.g. ‘Thursday 23 January’). Alternatively, all the ranges may be defined relative to the baseline value or in absolute terms (i.e. without reference to the baseline value).

A featured or focal display area within the graphical user interface is defined for display of the group of data items having a reference parameter value closest to the focal value of the reference parameter. This group may be referred to as the ‘selected group’ as it is selected from all the groups of data items based on being closest (in terms of its range of reference parameter values) to the focal value. The focal display area comprises a primary display area and may also comprise one or more secondary display areas. A plurality of subsidiary display areas are also defined within the graphical user interface and these are configured to display groups of data items that are not the closest group to the focal value. i.e. they are configured to display non-selected groups.

In response to a scroll input (which results in a change to the focal value), the grouping of data items remains unchanged for non-selected groups (i.e. for those groups where the range of reference parameter values does not overlap with, or is not closest to, the updated focal value). However, for the group of data items that does overlap with (or is closest to) the updated focal value, and hence is the selected group, the group is sub-divided into a plurality of sub-groups, each sub-group corresponding to a smaller range of reference parameter values and each sub-group comprising those data items with reference parameter values falling within the corresponding smaller range. The sub-division may be performed relative to the focal value and spread of data items in the selected group such that there is always a sub-group that overlaps the focal value and comprises at least one data item. In other examples, the sub-division may be performed independently of the focal value and spread of data items in the selected group. The sub-group that is closest to the focal value and that comprises at least one data item is displayed in the primary area of the focal display area and any other sub-groups that comprise at least one data item are displayed in the secondary areas of the focal display area. If only one sub-group comprises a data item, the secondary display areas of the focal display area are omitted.

Those data items in the sub-group displayed within the primary area of the focal display area are displayed according to a first set display parameters for the focal display area and those data items in sub-groups in the secondary areas of the focal display area are displayed according to a second set of display parameters which are different to the first set. The display parameters used to display data items in non-selected groups in the subsidiary display areas may be the same as for the sub-groups in the secondary areas of the focal display area (i.e. the second set of display parameters) or may be different (e.g. a one or more other sets of display parameters). Each subsidiary display area has a corresponding set of display parameters and the same or different sets of display parameters may be used by different subsidiary display areas.

When a data item is rendered in the graphical user interface, it is rendered according to the set of parameters for the display area in which it is rendered. Consequently, a data item rendered in the primary area of the focal display area is rendered according to the first set of display parameters, a data item rendered in the secondary area of the focal display area is rendered according to the second set of display parameters and any data item rendered in a subsidiary display area is rendered according to the display parameters for that subsidiary display area. This also means that where, in response to a scroll input, a group, or sub-group, of data items moves from one display area to another, it may be rendered according to a different set of display parameters.

The first set of display parameters may define a display size for a data item that is large enough to provide details of the event a first level of detail such as including the time, organizers, location, and the like. The first size may also be large enough to include one or more inputs rendered for performing actions with respect to the data items, such as joining or performing another action with respect to an online meeting or other online event associated with a calendar event.

In response to a subsequent scroll input, if the focal value is changed by a large enough amount such that it no longer overlaps with range of reference parameter values of the previously selected group of data items, the sub-groups of the previously selected group are all merged and the different group that now overlaps with the focal value becomes the selected group and is sub-divided, as described above.

If, however, the subsequent scroll changes the value of the focal value by a smaller amount, such that it still overlaps with the previously selected group, the selected group is unchanged. The sub-division of the selected group may be adjusted (e.g. where the sub-division is performed relative to the focal value) or the sub-division may remain unchanged. In either situation, a sub-group is selected for display within the primary area of focal display area based on the updated focal value and the other sub-groups are displayed in the one or more secondary areas of the focal display area. This may result in sub-groups of data items moving between the different areas within the focal display area. As described above, the sub-group that is selected for display in the primary area is the sub-group that is closest to the focal value and comprises at least one data item.

This difference in grouping of data items for display dependent upon whether the range of reference parameter values for the group overlaps with the focal value or not (i.e. dependent upon whether the group is the selected group or a non-selected group) provides a first aspect of the non-linear scrolling. The change to the display of a data item in response to a scroll input depends upon the group to which the data item belongs and the proximity of that group to the focal value. For groups distant from the focal value, motion that is rendered in response to the scroll input is applied in the same way to all displayed data items in the group and may result from the group moving from one subsidiary display area to another subsidiary display area, whereas for the group closest to the focal value (the selected group), the motion that is rendered differs for different data items as a consequence of the sub-division of the group.

A second aspect of the non-linear scrolling results from the different display parameters that are used to render data items for different groups. As described above, a first set of display parameters is associated with the primary area of the focal display area and is applied to data items displayed in the primary area of the focal display area. These display parameters define a highest level of detail and largest display size of all the sets of display parameters used. A second set of display parameters is applied to those data items in sub-groups that are rendered in the secondary areas area of the focal display area and the second set defines a lower level of detail and smaller display size than the first set of display parameters. The scrolling is described as non-linear for this aspect since the change to the graphical user interface in response to the scroll input is not directly proportional to the magnitude of the scroll input but instead is dependent upon at least the difference between the first and second sets of display parameters and a number of data items in each group or sub-group.

In addition to, or instead of the first and/or second aspects above, a third aspect of the non-linear scrolling may also be implemented. According to this third aspect, there is a non-linear relationship between the scroll input received (e.g. the magnitude of the scroll input received) and the resulting change in the focal value. Whilst the scrolling action by a user changes the focal value, the amount by which the focal value changes may depend upon both the magnitude of the scroll input and a difference between the focal value (before any update) and the baseline value. According to this aspect, a scrolling input that is received when the focal value is closer to the baseline value results in a smaller change to the value of the focal value than a scrolling input of the same magnitude (i.e. an identical scrolling input) that is instead received when the focal value is further from the baseline value. Any suitable non-linear relationship may be defined.

Computing devices include a wide variety of physical displays for outputting data to a user. Many computing devices, such as mobile phones, tablets, and the like, have limited hardware display sizes creating the technical problem that these display sizes can make it difficult for a user to efficiently view data. For example, a user may have many events scheduled on a respective calendar, creating difficulty in seeing the events on the calendar, especially for users that have visual impairments. To solve the above technical problem and to facilitate efficient use of the display space for these hardware displays and efficient display of large collections of data items, examples disclosed herein implement non-linear scrolling according to one or more of the aspects detailed above.

The non-linear scrolling described herein provides a more granular (or detailed) human-machine interface (or interaction) for navigating through a collection of data items with reference parameter values that are closer to the focal value (and where the third aspect is used, also the baseline value)—with a scroll input resulting in a group of data items overlapping with the focal value being sub-divided into smaller ranges of reference parameter and displayed in separate areas of the user interface—and a less granular human-machine interface (or interaction) for data items with reference parameter values further from the focal value (and where the third aspect is used, also the baseline value) since these groups are not sub-divided and are updated in unison in response to a scroll input. This enables efficient navigation and display of data items which have reference parameter values that span a large range (e.g. a series of calendar entries which span several months), even when using a small area display.

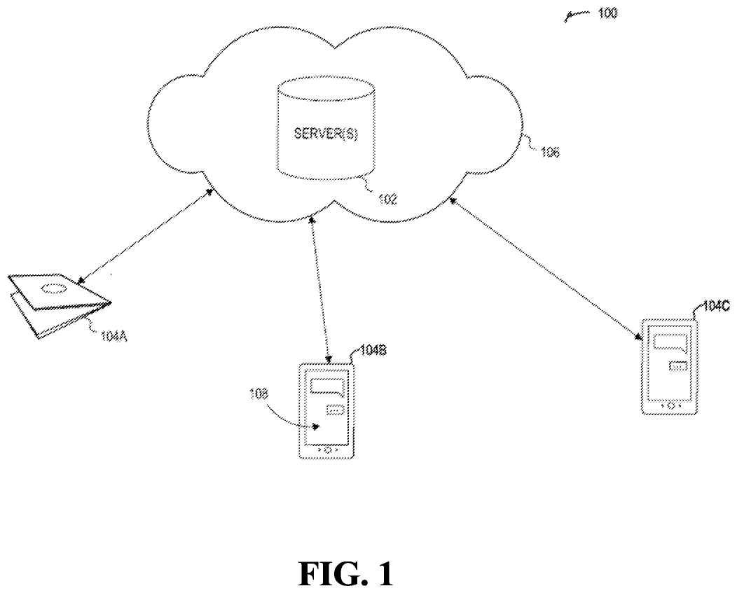

FIG. 1 is a diagram illustrating an example system 100 for generating a user interface. The system 100 includes one or more servers 102 and user devices 104a-104c. The user devices 104a-104c may be any user devices connected to the one or more servers 102 through one or more networks 106. The one or more networks 106 may include cellular networks, local area networks, wide area networks, and the like. For example, the networks 106 may include the wireless networks such as 3rd generation (3G). 4th generation (4G), long term evolution (LTE). 5th generation (5G) or any other cellular network, wireless networks according to the Institute of Electrical and Electronics Engineers (IEEE) 802.11 family of standards known as Wi-FiR, and the like. The user devices 104a-104c may be configured to communicate with the servers 102 through any connection, including wired and wireless connections. Each user device 104a-104c, which may be a phone, tablet, laptop, wearable device or other computing device, may be configured to upload data to, and download data from the servers 102.

The servers 102 may include one or more applications configured to collect and compile data for one or more users of the user devices 104a-104c. In some examples, the application is a calendar application configured to collect and compile event data for the users. In some examples, the user devices 104a-104c may execute an “offline” application such that communication with the servers 102 is not needed.

In some examples, the user devices 104a-104c may have physical display devices, such as the mobile device display 108, that are of limited size. For example, a tablet or mobile phone often has a physical display that is much smaller than a desktop computing system. Therefore, it is desirable to provide an efficient display of information such that a user is able to easily view and access data items on smaller physical display devices.

As described above, a featured or focal display area may be defined within the graphical user interface for display of a group of data items having a value of a reference parameter closest, or otherwise within a threshold (or range) of, the focal value. In some examples, a docked display area may also be defined where the focal value differs from the baseline value (or differs by more than a predefined amount). The docked display area is for display of a data item that has a reference parameter value that is closest to the baseline value and in various examples, the docked display area may only display a single data item. The docked display area is separate from the focal display area and unlike the focal display area, the data items displayed in the docked display area not updated in response to a scroll input (and hence a change in the focal value) but is instead is updated in response to a change to the baseline value. The presence or absence of the docked display area is, however, dependent upon the focal value because, as described above, the docked display area may only be defined where the focal value differs from the baseline value (or differs by more than a predefined amount). A third set of display parameters may be used to display the data item in the docked display area and this third set of display parameters may be the same as or different from the first set of display parameters. For example, the third set of display parameters may define a size and level of detail that is lower than the first set of display parameters and higher than the second set of display parameters. As detailed above, the display parameters used to render a data item within the user interface depend upon the area of the user interface in which the data item is rendered.

As described above, groups of data items are rendered on the display outside of both the focal display area and the docked display area (where provided) in a plurality of subsidiary display areas and the number subsidiary display areas, and hence the number of groups, that are displayed will depend upon at least the size of the display device and the size at which the data items are displayed (as specified by the sets of display parameters for each display area). These groups of data items which are displayed outside of the focal display area may be displayed with varying sizes and levels of detail. e.g. according to a fourth or subsequent set of display parameters, dependent upon the display parameters associated with the subsidiary display area in which the group is rendered. The sizes and levels of detail may be smaller and less, respectively, than that for the data item displayed within the primary area of the focal display area according to the first set of display parameters. For example, the first set of display parameters may define that data items in the primary area of the focal display area may include full details for the event (e.g., scheduled time, event title, event location, event organizer, etc.). The data items displayed outside of the primary area of the focal display area may include a lesser level of detail, such as by displaying fewer properties or abbreviated property data. The set of display parameters that are used for any subsidiary display area may depend upon a difference between the focal value and the range of reference parameter values of the data items in the group displayed within the subsidiary display area, with groups that have reference parameter values further from the focal value displayed using a set of display parameters defining a smaller size and reduced level of detail compared to a set of display parameters used for a group having reference parameter values closer to the focal value. In some examples, a set of display parameters (and hence the size and level of detail) may be selected for a subsidiary display area as a function of both the proximity of the reference parameter values for the group of data items to the focal value, and a number of data items having reference parameter values that fall between that of the first data item in the group and the focal value. In some examples, the size of the display may also be used in selecting the size or level of detail and/or in setting the ranges used to define the groups of data items. To scroll the data items on the graphical user interface, a user may provide a scroll input such as through a touchscreen, scroll wheel, selection of a scroll bar control, gesture on a touchpad, or the like. The scroll input that is received may also be received via a different user input device (e.g. a head mounted display) and/or different types of user interaction, such as discrete button clicks (e.g. clicks on a mouse button or key presses on arrow buttons on a keyboard). The scroll input may change the focal value (e.g., from a current time to a future time for a calendar interface) dependent upon the magnitude of the scroll input. The magnitude of the scroll input may correspond to a magnitude of the scrolling, swiping or dragging action (which may be scaled in some way. e.g. dependent on the magnification of the display) or a number of discrete button clicks. The data items, in response to the scroll input, may be rendered according to the new focal value. As described above, where the third aspect of non-linear scrolling is used, the change to the focal value is not directly proportional to the magnitude of the scroll input but is instead also dependent upon a difference between the focal value and the baseline value of the reference parameter.

As part of providing the “non-linear” scrolling of the user interface, the ranges of reference parameter values that define the grouping of data items may not be equal. For example, the ranges may be selected based on a total number of data items, a total number of data items within a specified range, or any other data. In the example of a calendar interface, a first range, close to the baseline value, may be a time span of half of a workday (e.g., four hours), while a second range may be a time span of one or two days. These ranges (or time spans) may be selected based on a total number of events scheduled for a user and/or other data. For example, if a user has very few events scheduled, the range closest to the baseline value may be a present day, the second range may be the remainder of the week, and a third range may be the remainder of the month. All these ranges are relative, in that they are defined with respect to the baseline value. There may additionally be one or more absolute ranges (e.g. “January”, “February”, etc.). Whereas, for a user with many events, the first range (closest to the baseline value) may be much shorter, such as the next two hours, the second range may be the remainder of the day, and the third range may be the next two days. Thus, the calendar events are displayed as a function of both a proximity of the scheduled time of the event to the focal value, and a total number of events scheduled between the respective event and the focal value. The grouping of data items dependent upon the number and spread of data items with reference to their reference parameter values provides a further aspect of non-linear scrolling and provides the user with an efficient view of events that are further into the future.

In examples where the ranges are dependent upon a total number of data items within a specified range of values of reference parameter, the user does not need to scroll through an empty schedule to reach upcoming events, but rather gets an efficient and accurate picture of upcoming events regardless of the frequency of the events.

The display sizes (i.e. display parameters and sizes of the different display areas) and ranges that define groups of data items may be set by one or more applications executing on a device associated with the hardware display, for example, such as a mobile phone, tablet, wearable device, personal computer, and the like. The sizes and ranges may also be set by one or more applications executing on a remote server, for example, in communication with the device associated with the hardware display. In some examples, machine learning may be used to select optimal display sizes and ranges for various collections of data items.

In other examples, a user may select preferences for display sizes and property value ranges. In an example, a user may always desire five display areas (e.g. the focal display area and four subsidiary display areas) each including between one and four data items and the data items may be grouped to meet a user's requirements.

Using the methods described herein, data items are more efficiently displayed to users while still providing the user with desired detail for respective data items. At a glance, the user may view items and details of those items that are of immediate interest (e.g., that are within the focal or docked display areas), while still viewing an overview of items that are not within immediate interest so as to get a perspective of upcoming items. This is especially advantageous for users with smaller hardware displays such as users of mobile devices. This also provides accessibility for users having visual impairments such that even with large collections of data items, the most relevant data items can be provided with a larger size, allowing a user to more easily review desired data items.

In some examples, the initial focal value may correspond to the baseline value, e.g. when opening an application and before any scroll input is received or upon resetting a view of the user interface. Where a docked display area is used, this means that initially there is no docked display area but it may be generated in response to a scroll input. As described above, the docked display area displays a data item having a reference parameter value closest to the baseline value. In examples where initial focal value is equal to the baseline value (e.g. upon opening or resetting the user interface), then the data item that is displayed in the docked display area is a data item that was initially displayed in the primary area of the focal display area but which has subsequently been moved out of the primary area of the focal display area to be replaced by other data items as a consequence of scroll input being received that changes the focal value. As described above, the docked display area may only be shown where the baseline value is not the same as the focal value (e.g. so that the primary area of the focal display area and the docked display area do not both include the same data item).

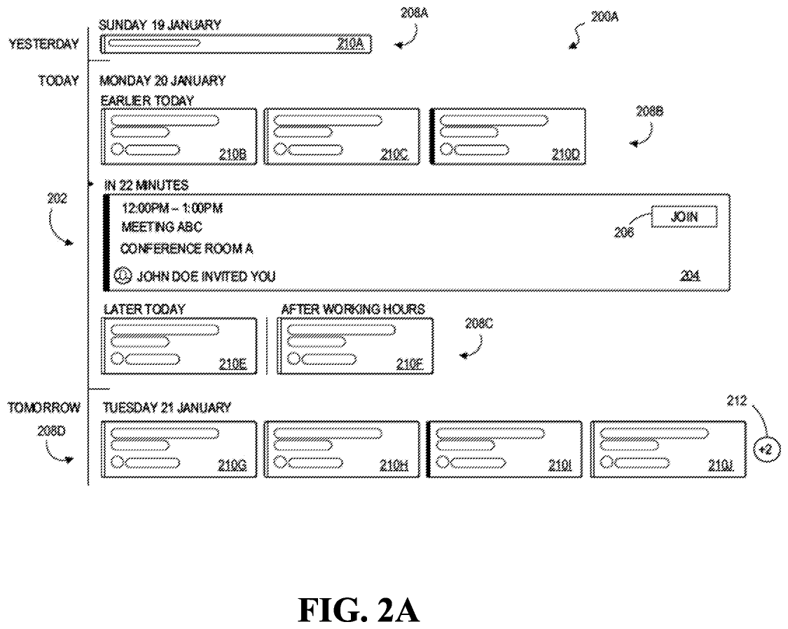

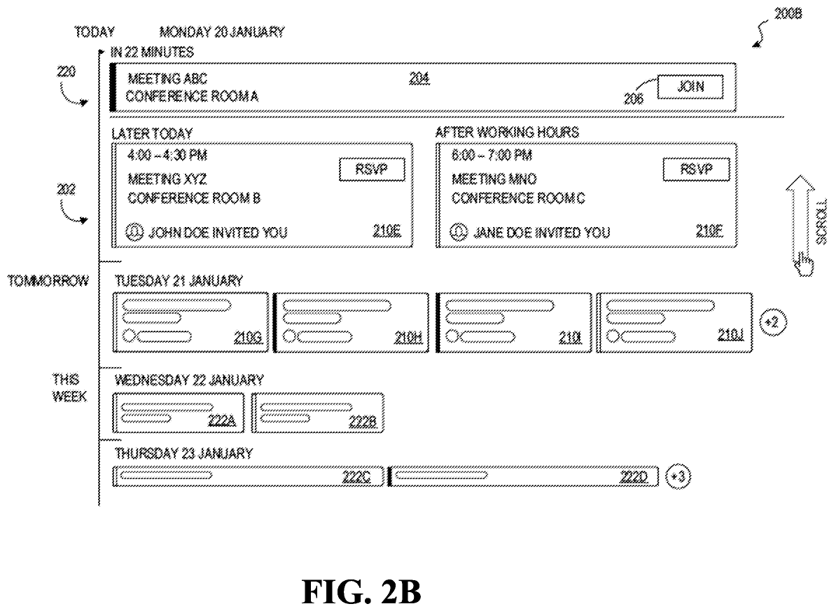

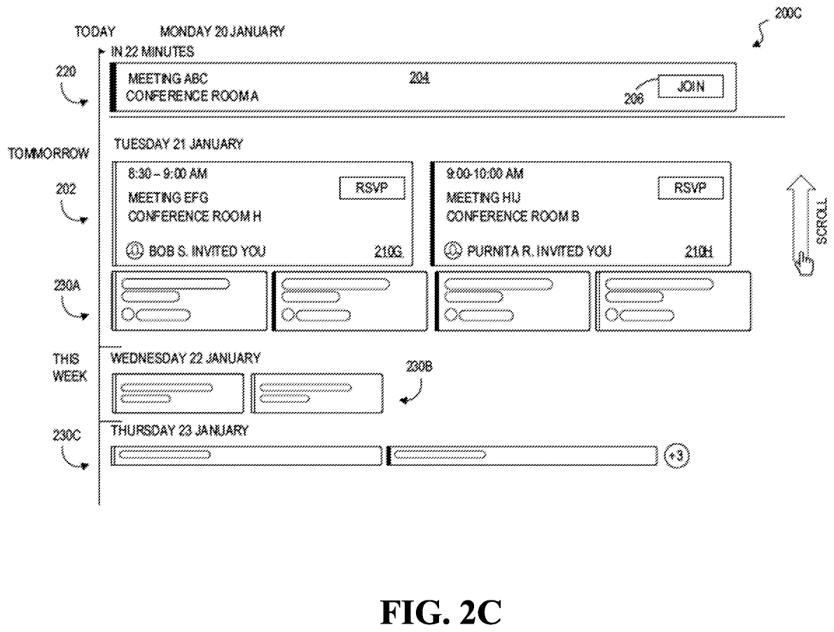

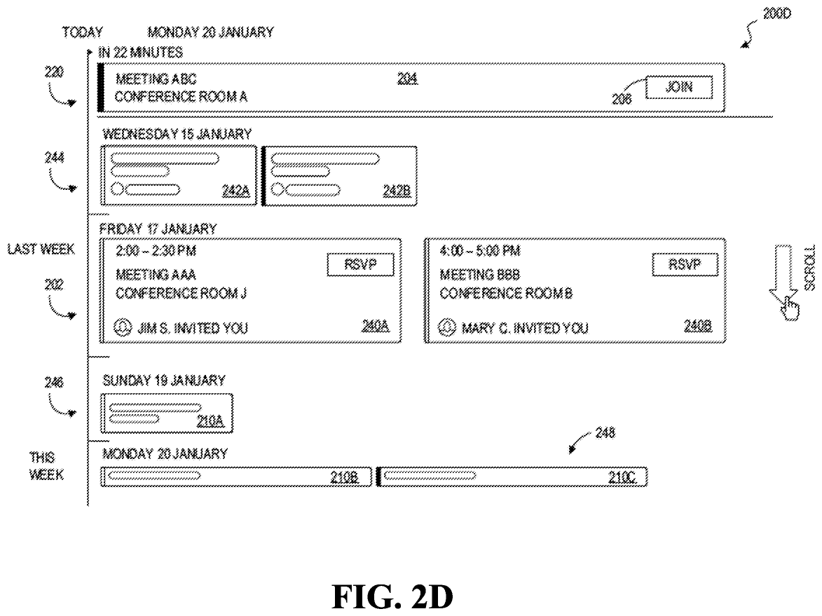

FIGS. 2A-2D are diagrams illustrating example user interfaces 200A-200D for a calendar application or other application that displays data items, such as MICROSOFT TEAMS®. While illustrated with calendar events, the data items may be any data items illustrated in a user interface. For example, a file interface may be used to display data files to a user. Rather than calendar events, the data items may be data files ordered according to one or more properties (e.g., size, file type, data created, date edited, and the like). Furthermore, whilst FIGS. 2A-2D show a combination of several different features (e.g. docked display, focal display area, relative and absolute ranges), it will be appreciated that this is for ease of explanation only and the features may be used independently of each other or in any combination of two or more features.

The user interfaces 200A-200D may be rendered and presented on a physical display, such as the physical display 108 or other physical display of any of the user devices 104a-104c, for example.

FIG. 2A illustrates an initial graphical user interface 200A for the application. This initial interface 200A may be an initial display rendered upon a user opening the application, providing a reset input, re-opening a tab of a parent application, or the like. The interface 200 may occupy a portion or the full display area of a hardware display. For example, the interface 200 may open display as a window of an operation system which may have a display size smaller than the full hardware display and may be controlled by the user to increase in display size to the full hardware display. The interface 200 includes a primary area of a focal or featured display area 202 along with two secondary areas 202B and 202C, which may be defined by a focal value. The selected group of data items corresponds to ‘today’ or ‘Monday 20 January’ as selected based on the focal value. In some examples, an initial value of the focal value is the baseline value which may be a present time. Event 204 is the only scheduled event in the closest sub-group to the focal value (e.g. to the initial time) and hence is displayed in the primary area 202. Two other sub-groups are defined, a first comprising events 210B-210D and a second comprising events 210E-210F. Each of these sub-groups is displayed in one of the secondary areas 208B. 208C. For other examples, such as file browser interfaces, the focal value may be a created time, and edited time, a file size, or the like.

The event 204 is displayed in the primary display area 202 at a first size and with a first level of detail. While illustrated as substantially spanning the width of the interface 200A, the first size may be any selected size for the primary area 202. Additionally, the primary display area 202 may be configured to occupy any desirable space of the interface 200A. The event 204 is sized such that a user is able to more easily view the event 204 and greater detail (e.g., full detail) for the event 204 can be presented. For example, as illustrated in FIG. 2A, the event 204 displays an event time, event title, event location, event organizer, and an input 206. The input 206, which may be a selectable button, for example, may be used to join a web conference or other online event associated with the event 204, RSVP for the respective event, or perform any other action with respect to the respective event. The input 206 may be positioned at any location on the displayed event 204.

The interface 200A also includes two subsidiary display areas 208A and 208D outside of the focal display area 202, 208B, 208C. Subsidiary display area 208A is for rendering a group of events with time spans (ranges of values of the reference parameter) that occur prior to the focal time span and the display areas 208D is for rendering a group of events with time spans (ranges of values of the reference parameter) that occur subsequent to the focal time span. It will be appreciated that there may be more than two subsidiary display areas. The display area 208A displays an event 210A, and the display area 208D displays events 208G, 208H, 208I, and 208J. The display area 208D also includes an indicator 212 to indicate that there are further events in the group of data items (and hence which are included within a time period of the display area 208D) but are not displayed as a consequence of the set of display parameters for that subsidiary display area 208D (e.g. which may define a maximum number of data items that can be rendered within the area).

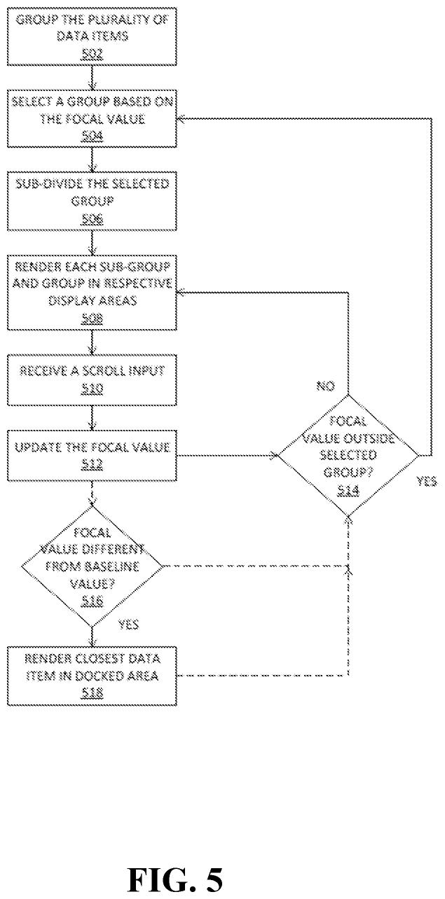

The size of the respective display areas 208A-208D may be determined based on a time span (range of values for the reference parameter), a number of events within the time span, a total number of display areas on the user interface, and the like. As discussed with respect to FIG. 5, the number of display areas, size of each display area, and time span of each display area may be specified by the user and/or by the application. For example, the application may use machine learning to determine an optimal display setup for the interface 200A. The machine-learning model may output the optimal values based upon one or more indicators. For a calendar application, example indicators may include total events, event frequency, the time of day, day of the week, day of the year, previous activities of the user, and the like. Past user data may be used to train the machine-learning model. Example machine-learning algorithms may include logistic regression, neural networks, decision forests, decision jungles, boosted decision trees, support vector machines, and the like.

FIG. 2B illustrates an interface 200B that results from a user scroll action on the interface 200A. While illustrated as a user swipe of a touchscreen display, the user may scroll the calendar view using a scroll bar, a gesture on a mousepad, a scroll wheel, or any other input through a touchscreen or other input device. In FIG. 2B, the scroll action has changed the focal value to a later time as compared with the interface 200A. In this example, the focal value has changed by an amount that is sufficiently small that the same group of data items is still selected (‘Today’/‘Monday 20 January’) but a different sub-group is displayed in the primary area 202. In this example, the focal time was changed to a time later in the day as the interface 200A. For example, the original focal time may have been 11:38 AM, and the new focal time may be 4:00 PM.

The calendar application may be configured to animate the movement of events during the scroll action. For example, the events 210E and 210F may be animated to display movement from the display area 208C (a secondary display area) of the interface 200A to the display area 202 (the primary display area) of interface 200B. The increase in size of the events 210E and 210F (as a consequence of moving from a secondary display area to the primary display area) may also be animated. In other examples, as the user scrolls, the movement and change in size of the events may not be animated. For example, the events 210E and 210F may simply disappear from the display area 208C of the interface 200A and reappear at a new size in the display area 202 of the interface 200B.

As a result of the scroll action, the event 204, which occurs in 22 minutes from the present time, may be out of range of the calendar view. To keep the event 204 within view of the user, a “docked” display area 220 may be rendered in the interface 200B. In the example illustrated in FIG. 2B, the docked display area 220 is positioned at the top of the calendar view and in this example it means that the secondary display areas comprising the other sub-groups cannot be seen. In other examples, the display area 220 may be positioned at other locations on the interface 200B. As the interface scrolls, the event 204 can remain positioned within the display area 220. This way, a user of the calendar view is able to scroll through future or past events, while the upcoming event 204 remains easily accessible for the user. In other example interfaces, the docked display area may display any data item that includes a reference parameter that was once displayed in the focal display area and moved out of the focal display area by a scroll action or other input.

As shown in FIG. 2B, and where the ranges of reference parameters each correspond to one day, the same group is still overlapping with the new focal value (group ‘today’) but a different sub-group has been selected for display in the focal area (the third sub-group comprising events 210E-210F)—the other sub-groups are not visible in FIG. 2B. The grouping of other data items remains unchanged. e.g. the group comprising events 210G-210J, plus two more events indicated by the symbol 212, remains unchanged from that shown in FIG. 2A and all the events from the group that are displayed (events 210G-210J) have undergone the same motion in response to the scroll input (e.g. they have been subject to the same translation across the screen space as they move from one subsidiary display area to another subsidiary display area). As a consequence of the scrolling, new groups of data items are displayed at the bottom of the screen in the subsidiary display areas. As shown in FIG. 2B, the number of subsidiary display areas that are displayed may change in response to the scroll input, e.g. as a consequence of the number of data items in each group of display items that are displayed.

Because the focal value has changed, a different sub-group of event(s) may be brought into the primary display area 202. In the example illustrated in FIG. 2B, events 210E and 210F are brought into the primary display area 202. The events 210E and 210F that are now in the primary area are displayed at a larger size and with a greater level of detail as compared to the interface 200A when the respective events 210E and 210F were outside of the primary display area 202. This is a consequence of events being rendered according to the set of display parameters corresponding to the display area in which they are rendered. Also, in the example illustrated in FIG. 2B, the primary display area 202 has changed position and size as compared to the interface 200A. In some examples, the primary display area 202 may remain in the same position when scrolling. Events outside the primary display area 202 are also adjusted based on respective properties (e.g., scheduled times). For example, the events 210G-210J are moved up on the interface 200B into a new subsidiary display area. While illustrated as having a similar size as compared to the interface 200A, one or more of the events 210G-210J may be increased in size and/or display a greater level of detail as well as moving across the display. Events 222A-222D, which were not displayed on the interface 200A, are brought into the display for the interface 200B as a result of the scrolling action. These events 222A-222D are displayed at sizes smaller than the events 210G-210J and with a lesser level of detail due to being scheduled further out from the updated focal time with respect to the events 210G-210J.

FIG. 2C illustrates another example interface 200C in which a user has scrolled the calendar view of interfaces 200A and 200B further into the future. While illustrated as a user swipe of a touchscreen, the user may scroll the calendar view using a scroll bar, a gesture on a mousepad, a scroll wheel or any other input from the user through a touchscreen or other input device. In FIG. 2C, the focal time is set by the scroll action to the following day. For example, the focal value for FIG. 2B may have been 4:00 PM while the updated focal time for FIG. 2C may be 8:00 AM the following day (illustrated as Tuesday, January 21^{st}). In this example, the focal value has changed by an amount that is sufficiently large that a different group of data items is selected (‘Tuesday 21 January’). As seen in FIG. 2B, the group of events corresponding to Tuesday, January 21^{st} comprises six events. In FIG. 2C, the group comprising six events is sub-divided into two sub-groups and displayed in separate display areas. The two events 210G and 210H in the sub-group closest in scheduled time to the focal value are displayed in the primary display area 202. The remaining four events for Tuesday, January 21^{st} (in the other sub-group) are displayed in a secondary display area 230A within the focal display area. Because they include property values (e.g., scheduled times) that are further from the focal time than the two events 210G and 210H, the remaining four events are displayed at a smaller relative size and with a lesser level of detail. Two further subsidiary display areas 230B and 230C are positioned to display events for groups of events corresponding to the following two days, respectively. The event 204 remains positioned on the screen in the docked display area 220 and does not move with the scroll action between interface 200B and 200C.

FIG. 2D illustrates another example interface 200D, in which a user has scrolled the calendar view of the interface 200A to a focal time in the past. While illustrated as a user swipe of a touchscreen, the user may scroll the calendar view using a scroll bar, a gesture on a mousepad, a scroll wheel, or any other input from the user through a touchscreen or other input device. Similar to scrolling to the value of the reference parameter to a future focal time, the event 204 is displayed in the docked display area 220 due to scrolling the focal value away from the baseline value such that the closest event to the baseline value is no longer in the focal area. In the example illustrated in FIG. 2D, the focal value for the reference parameter is changed to the previous Friday to view past events on a user's calendar. For example, the focal value for the interface 200A may have been 11:38 AM, and the new focal value may be Friday, January 17^{th}, at 12:00 PM.

The group of events 240A and 240B, which have property values (e.g., scheduled times) closest to the new focal value, are displayed within the primary display area 202—no secondary display areas are shown as they do not comprise any events. Events 242A and 242B from Wednesday. January 15^{th} are displayed in a subsidiary display area 244 at a size smaller, and with a lesser level of detail, than the events 240A and 240B as they are scheduled further from the focal time and outside of the focal time span for the focal display area 202. The event 210A is displayed in a subsidiary display area 246 and the events 210B and 210C are displayed in a subsidiary display area 248.

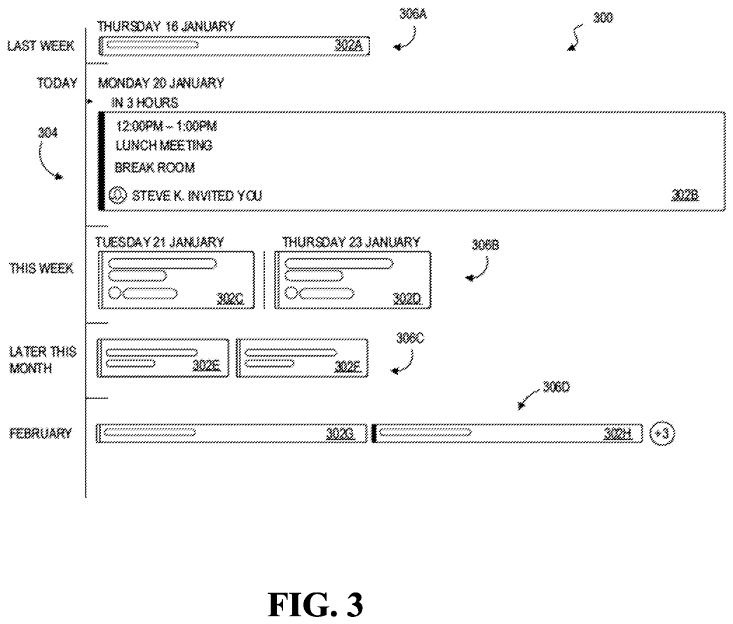

FIG. 3 illustrates another example interface 300. The example interface 300 illustrates a calendar view for a user that has fewer events 302A-302H scheduled than the example user for the interfaces 200A-200D and as a result the ranges that have been used to define the grouping of events is different and in this example, the ranges are not equal in size (e.g. by week closest to the baseline value and then “later this month” followed by ‘February’). The event 302B is scheduled closest to the current focal value of the reference parameter (e.g., time) and is displayed within the primary area of the focal display area 304. This event 302B is the only event in a first sub-group that is formed by sub-dividing the group of events closest to the focal value. The event 302B is displayed larger, and with a greater level of detail, than the other events to provide focus for the event. An event 302A from the prior week (where the data items may be grouped by week) is displayed in a subsidiary display area 306A. The event 302A may be the closest scheduled previous event to the focal value outside of a threshold time span, such as the day of Monday. January 20^{th}.

The user of the interface 300 may only have two further events 302C and 302D scheduled for the week and hence these form the second sub-group created by the sub-division of the “this week” group, which may be displayed in a secondary display area 306B of the focal display area. Due to the events being upcoming, and relatively close in scheduled proximity to the focal value, the events 302C and 302D displayed in the secondary display area 306B may be displayed at a larger size, and with a greater level of detail, than the event 302A. In other examples, the events 302C and 302D may be displayed at a size smaller, and with a lesser level of detail, than the event 302A. The subsidiary display area 306C may display the two remaining events 302E and 302F for the user for the month, and the subsidiary display area 306D may illustrate two events 302G and 302H for the following month. The display areas 306A-306D display events across larger time spans as compared to the display areas of the interfaces 200A-200D due to the user having fewer total events. This allows efficient use of a display screen regardless of the number of events that a user has scheduled, and prevents the user from having to scroll through empty calendar to get an overview of upcoming events.

While described with respect to a calendar application, the same non-linear scrolling described with respect to FIGS. 2A-2D and 3 can be applied to other user interfaces including messaging applications, file browsers, streaming applications, web browsers, and the like. For example, the calendar events described above may be any data items for any application. For example, data items for a messaging service may include messages between one or more users, data items for a file browser may be data files of various file types, data items for a web browser may be bookmarked web pages, and the like.

With respect to other applications, the time spans described with respect to FIGS. 2A-2D and 3 can be any value ranges for any reference parameters. For example, for messaging applications, the reference parameter value ranges may also be time spans, whereas for a file browser, the reference parameter value ranges may be time spans (e.g. creation and/or edit dates), file types, file names, and the like.

As mentioned above, the ranges of parameter values may be defined relatively or absolutely and FIG. 3 shows a combination of these: ‘last week’, ‘this week’ and ‘later this month’ are defined relatively whereas ‘February’ is defined absolutely.

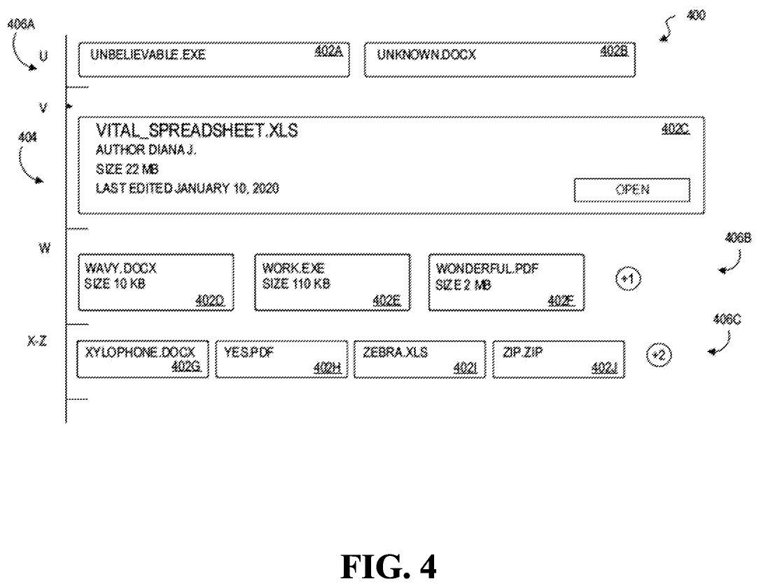

FIG. 4 illustrates an example user interface 400 for a file browser that includes non-linear scrolling of data items 402A-402J using file name as the reference parameter. In this example, the reference parameter value ranges may be alphabetical such that a focal display area 404 displays data items within a alphabetical value range. A value of the reference parameter may be one or more specified letters. In FIG. 4, the reference parameter value range for the featured focal area 404 is all files starting with the letter “V”, which is one file in the illustrated example.

A third display area 406A may include all data items (files) that start with the letter “U”, a third display area 406B may include all data items that start with the letter “W”, and a fourth display area 406C may include all data items that start with any of the letters “X”-“Z”. For systems with many more files, the reference parameter value ranges for each display area may be much smaller. For example, a focal parameter value range may include any files that start with the letters “DAT”, while a second display area may include files that start with “DAV-DEA”, and a third display area may include all remaining files that start with “D”.

The interface 400 may be scrolled in a similar manner as described with respect to interfaces 200A-200D and 300. For example, a user may scroll the interface 400 to change a focal value of the reference parameter such as from the letter “V” to the letter “G”. Upon doing so, the featured display range 404 may change to display data items that have names starting with the letter “G”. The display area 406A may change to have a reference parameter value range that includes data items that have a name starting with “F”, starting with “E” or “F”, or any other range. The display areas 406B and 406C may also have respective reference parameter value ranges updated. For example, the display area 406B may be updated with a parameter value range of all file names starting with the letters “H” and “I”, and the display area 406C may be updated with a reference parameter value range of all file names starting with letters “J-N”. In some examples, the displays areas 402 and 404A-404C may be resized, repositioned, and/or removed upon a user scroll action. Further display areas may also be added upon a user scroll action.

FIG. 5 is a flowchart illustrating a first example method 500 of providing an improved user interface. While method 500 is described with respect to a calendar interface, method 500 may be used for any other graphical user interface. Method 500 may be executed by one or more processors of a computing device executing instructions stored by a memory of the computing device, for example.

Method 500 describes techniques for efficiently using a display area of a hardware display for a user interface. Data items are rendered and displayed on the user interface at varying sizes based on a focal parameter value, such as a focal time. When the focal parameter value changes due to a scroll input or other input, the size and position of the data items is adjusted based on the updated focal parameter value such that a user is able to scroll through the data items in a non-linear fashion. This allows more efficient display of focused data items in response to scroll inputs while still providing overall detail for a wide range of data items across varying amounts and concentrations of data items.

The method comprises grouping the plurality of data items into a plurality of groups (block 502). As described above, each data item has a value of a reference parameter and each group of data items comprises data items within a different, non-overlapping range of reference parameter values. A focal display area and a plurality of subsidiary display areas are defined within a graphical user interface. The focal display area is configured to display data items from a selected group and comprises a primary display area and a secondary display area. The primary display area has an associated first set of display parameters and the secondary display area has an associated second set of display parameters. As described above, the first set of display parameters is different from the second set of display parameters. The subsidiary display areas are each configured to display data items from a different, non-selected group and each subsidiary display area has an associated set of display parameters different from the first set of display parameters. The method further comprises selecting a group of data items having a range of reference parameter values closest to a focal value (block 504) and sub-dividing the selected group of data items into a plurality of sub-groups (block 506). As described above, each sub-group comprises data items having a smaller range of reference parameters than the selected group.

The sub-group that is closest to the focal value is rendered in the primary area, other sub-groups are rendered in the one or more secondary areas of the focal display area and a different non-selected group of data items is rendered in each of the subsidiary display areas (block 508). When rendering a data item (in block 508), each data item is rendered according to the set of display parameters for the area in which is rendered.

In response to receiving a scroll input from a user (block 510), the focal value is updated based on a magnitude of the received scroll input (block 512). As described above, where the third aspect is used, the update to the focal value (in block 512) is based on both a magnitude of the scroll input and a difference between the focal value and the baseline value.

If the updated focal value is outside of the range of the selected group (‘Yes’ in block 514), the method is repeated (as indicated by the arrow back to block 504). A new group of data items is selected based on the updated focal value (in block 504) and the newly selected group of data items is sub-divided into a plurality of sub-groups (block 506). Rendering occurs as described above (in block 508).

If, however, the updated focal value is still inside the range of the selected group (‘No’ in block 514), a new group does not need to be selected or sub-divided (blocks 504 and 506 can be omitted) and so the method proceeds (as shown by the arrow back to block 508) with the rendering operation (in block 508). As described above, this comprises rendering a sub-group that is closest to the updated focal value in the primary area, rendering other sub-groups in the one or more secondary areas of the focal display area and leaving the rendering of the non-selected groups of data items unchanged.

Where a docked display area is used, the method of FIG. 5 also comprises, in response to the scroll input and after updating of the focal value (in block 512), determining whether the updated focal value is different from, or is separated by more than a threshold value from, the baseline value (block 516). If the updated focal value is different from, or separated by more than a threshold value from, a baseline value (‘Yes’ in block 516), a docked display area is defined within the graphical user interface and a data item having a reference parameter that is closest to the baseline value is rendered in the docked display area (block 518). Whilst FIG. 5 shows blocks 516-518 occurring before block 514, where a docked display is used (as indicated by the dotted arrows), in other examples, blocks 516-518 may be implemented substantially in parallel with blocks 514 and 508 or blocks 514 and 504-508 (dependent upon the outcome in block 514).

Whilst the method of FIG. 5 shows use of a docked display area in combination with the sub-dividing of the selected group (in block 506), in other examples, the method of FIG. 5 may be used with a docked display area (e.g. including blocks 516-518) but omitting the sub-division block (block 506). In such an example, where the sub-division of the selected group is not performed, the focal display area is not subdivided into a primary display area and a secondary display area and instead comprises a single area. The first set of display parameters may be used when rendering the entirety of the selected group in the focal display area. In such an example, the docked display area may be used separately from any of the non-linear scrolling aspects described herein.

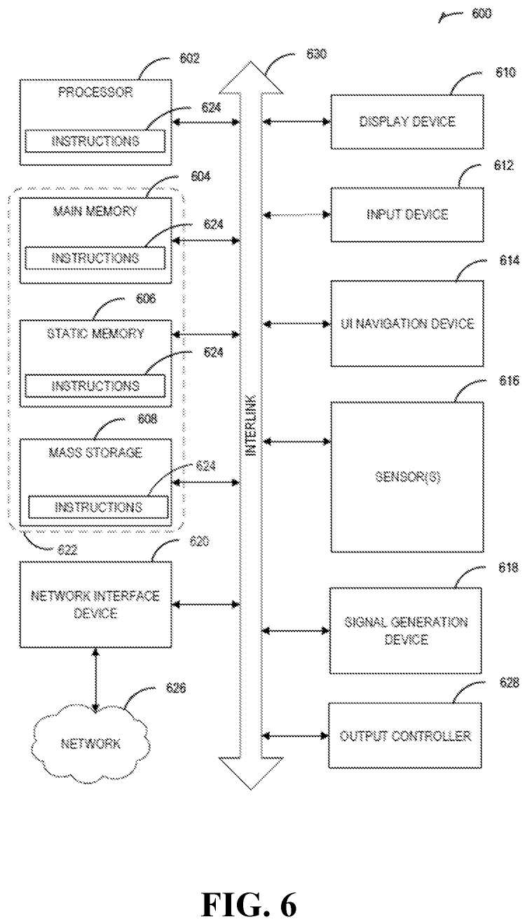

FIG. 6 illustrates a block diagram of an example machine 600 upon which any one or more of the techniques (e.g., methodologies) discussed herein may perform. For example, the machine 600 can be any one or more of the servers 104, and/or computing devices 102a-102c. Examples, as described herein, may include, or may operate by, logic or a number of components, or mechanisms in the machine 600. Circuitry (e.g., processing circuitry) is a collection of circuits implemented in tangible entities of the machine 600 that include hardware (e.g., simple circuits, gates, logic, etc.). Circuitry membership may be flexible over time. Circuitries include members that may, alone or in combination, perform specified operations when operating. In an example, hardware of the circuitry may be immutably designed to carry out a specific operation (e.g., hardwired). In an example, the hardware of the circuitry may include variably connected physical components (e.g., execution units, transistors, simple circuits, etc.) including a machine readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuitry in hardware via the variable connections to carry out portions of the specific operation when in operation. Accordingly, in an example, the machine readable medium elements are part of the circuitry or are communicatively coupled to the other components of the circuitry when the device is operating. In an example, any of the physical components may be used in more than one member of more than one circuitry. For example, under operation, execution units may be used in a first circuit of a first circuitry at one point in time and reused by a second circuit in the first circuitry, or by a third circuit in a second circuitry at a different time. Additional examples of these components with respect to the machine 600 follow:

In alternative embodiments, the machine 600 may operate as a standalone device or may be connected (e.g., networked) to other machines. In a networked deployment, the machine 600 may operate in the capacity of a server machine, a client machine, or both in server-client network environments. In an example, the machine 600 may act as a peer machine in peer-to-peer (P2P) (or other distributed) network environment. The machine 600 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

The machine (e.g., computer system) 600 may include a hardware processor 602 (e.g., a central processing unit (CPU), a graphics processing unit (GPU), a hardware processor core, or any combination thereof), a main memory 604, a static memory (e.g., memory or storage for firmware, microcode, a basic-input-output (BIOS), unified extensible firmware interface (UEFI), etc.) 606, and mass storage 608 (e.g., hard drive, tape drive, flash storage, or other block devices) some or all of which may communicate with each other via an interlink (e.g., bus) 630. The machine 600 may further include a display unit 610, an alphanumeric input device 612 (e.g., a keyboard), and a user interface (UI) navigation device 614 (e.g., a mouse). In an example, the display unit 610, input device 612 and UI navigation device 614 may be a touch screen display. The machine 600 may additionally include a storage device (e.g., drive unit) 608, a signal generation device 618 (e.g., a speaker), a network interface device 620, and one or more sensors 616, such as a global positioning system (GPS) sensor, compass, accelerometer, or other sensor. The machine 600 may include an output controller 628, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

Registers of the processor 602, the main memory 604, the static memory 606, or the mass storage 608 may be, or include, a machine readable medium 622 on which is stored one or more sets of data structures or instructions 624 (e.g., software) embodying or utilized by any one or more of the techniques or functions described herein. The instructions 624 may also reside, completely or at least partially, within any of registers of the processor 602, the main memory 604, the static memory 606, or the mass storage 608 during execution thereof by the machine 600. In an example, one or any combination of the hardware processor 602, the main memory 604, the static memory 606, or the mass storage 608 may constitute the machine readable media 622. While the machine readable medium 622 is illustrated as a single medium, the term “machine readable medium” may include a single medium or multiple media (e.g., a centralized or distributed database, and/or associated caches and servers) configured to store the one or more instructions 624. The term “machine readable medium” may include any medium that is capable of storing, encoding, or carrying instructions for execution by the machine 600 and that cause the machine 600 to perform any one or more of the techniques of the present disclosure, or that is capable of storing, encoding or carrying data structures used by or associated with such instructions. Non-limiting machine readable medium examples may include solid-state memories, optical media, magnetic media, and signals (e.g., radio frequency signals, other photon based signals, sound signals, etc.). In an example, a non-transitory machine readable medium comprises a machine readable medium with a plurality of particles having invariant (e.g., rest) mass, and thus are compositions of matter. Accordingly, non-transitory machine-readable media are machine readable media that do not include transitory propagating signals. Specific examples of non-transitory machine readable media may include: non-volatile memory, such as semiconductor memory devices (e.g., Electrically Programmable Read-Only Memory (EPROM), Electrically Erasable Programmable Read-Only Memory (EEPROM)) and flash memory devices: magnetic disks, such as internal hard disks and removable disks: magneto-optical disks; and CD-ROM and DVD-ROM disks.

The instructions 624 may be further transmitted or received over a communications network 626 using a transmission medium via the network interface device 620 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g.,cellular networks), Plain Old Telephone (POTS) networks, and wireless data networks (e.g., Institute of Electrical and Electronics Engineers (IEEE) 802.11 family of standards known as Wi-FiR. IEEE 802.16 family of standards known as WiMax R). IEEE 802.16.4 family of standards, peer-to-peer (P2P) networks, among others. In an example, the network interface device 620 may include one or more physical jacks (e.g., Ethernet, coaxial, or phone jacks) or one or more antennas to connect to the communications network 626. In an example, the network interface device 620 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 600, and includes digital or analog communications signals or other intangible medium to facilitate communication of such software. A transmission medium is a machine readable medium.

### Non-Limiting Examples

Example 1 is a system for scrolling a plurality of data items in a graphical user interface for efficient use of a display area of a hardware display, the system comprising: means for defining a featured display area for the graphical user interface, the featured display area defined for display of ones of the plurality of data items based on a reference parameter, the reference parameter identifying a property value of interest for the plurality of data items: means for identifying a first data item of the plurality of data items for display in the featured display area, the first data item comprising a property value describing a property of the first data item, wherein the first data item is identified based on the property value being within a threshold of a first value of the reference parameter; means for rendering the first data item within the featured display area on the hardware display, the first data item rendered with a first display size and description text describing a first level of detail describing the first data item: means for selecting one or more second data items of the plurality of data items for display outside of the featured display area: means for rendering the one or more second data items outside of the featured display area on the hardware display, each of the one or more second data items rendered with respective second display sizes and description text describing a second level of detail for the respective second data items, each of the respective second display sizes smaller than the first display size, and the first level of detail displaying greater detail than the second level of detail: means for receiving a scroll input that changes a value of the reference parameter from the first value to a second value: means for identifying, in response to receiving the scroll input, one of the second data items for display in the featured display area, the one of the second data items comprising a property value describing a property of the one of the second data items, wherein the one of the second data items is identified based on the property value being within a threshold of the second value of the reference parameter; means for rendering, after receipt of the scroll input, the identified one of the second data items within the featured display area on the hardware display at the first display size and with description text describing the first level of detail; and means for rendering, after receipt of the scroll input, the first data item outside of the featured display area at the second display size and with description text describing the second level of detail based on the property value of the first data item being outside the threshold of the second value of the reference parameter, the second display size smaller than the first display size, and the second level of detail displaying less detail than the first level of detail.

In Example 2, the subject matter of Example 1 includes, wherein the means for selecting the one or more second data items comprises means for selecting all of the plurality of data items having respective property values within a second threshold of the first value of the reference parameter.

In Example 3, the subject matter of Examples 1-2 includes, wherein the means for selecting the one or more second data items comprises means for selecting a pre-specified number of the plurality of data items, the pre-specified number of the plurality of data items having respective property values closest to the first value of the reference parameter.

In Example 4, the subject matter of Examples 1-3 includes, means for rendering a docked item of the plurality of data items outside of the featured display area, wherein the docked item has a respective property value within a threshold of a third value of the reference parameter, and

wherein a display size and description text of the docked item does not change in response to receiving the scroll input.

In Example 5, the subject matter of Examples 1˜4 includes, wherein the means for rendering the first data item further comprises means for rendering an input selectable to perform an action associated with the first data item.

In Example 6, the subject matter of Examples 1-5 includes, wherein the one or more of second data items are grouped into a plurality of secondary display areas outside of the featured display area, and wherein each of the plurality of secondary display areas are defined to display data items for a respective range of values of the reference parameter, and wherein each of the one or more second data items within a respective group are displayed at a same display size.

In Example 7, the subject matter of Examples 1-6 includes, wherein the means for rendering the first data item in response to receiving the scroll input comprises means for rendering a scroll animation of the first data item from within the featured display area to outside the featured display area.

In Example 8, the subject matter of Examples 1-7 includes, wherein the first level of detail is displayed values for a first number of a plurality of properties of a respective data item, and wherein the second level of detail is displayed values for a second number of the plurality of properties of a respective one of the plurality of data items, the first number greater than the second number.

In Example 9, the subject matter of Examples 1-8 includes, wherein the first level of detail is full displayed values for one or more properties of a respective data item, and wherein the second level of data is abbreviated displayed values for the one or more properties of a respective data item, the abbreviated displayed values having less text than the full displayed values.

Example 10 is a method for scrolling a plurality of data items in a graphical user interface for efficient use of a display area of a hardware display, the method comprising: defining a featured display area for the graphical user interface, the featured display area defined for display of ones of the plurality of data items based on a reference parameter, the reference parameter identifying a property value of interest for the plurality of data items: identifying a first data item of the plurality of data items for display in the featured display area, the first data item comprising a property value describing a property of the first data item, wherein the first data item is identified based on the property value being within a threshold of a first value of the reference parameter; rendering the first data item within the featured display area on the hardware display, the first data item rendered with a first display size and description text describing a first level of detail describing the first data item: selecting one or more second data items of the plurality of data items for display outside of the featured display area: rendering the one or more second data items outside of the featured display area on the hardware display, each of the one or more second data items rendered with respective second display sizes and description text describing a second level of detail for the respective second data items, each of the respective second display sizes smaller than the first display size, and the first level of detail displaying greater detail than the second level of detail: receiving a scroll input that changes a value of the reference parameter from the first value to a second value: in response to receiving the scroll input: identifying one of the second data items for display in the featured display area, the one of the second data items comprising a property value describing a property of the one of the second data items, wherein the one of the second data items is identified based on the property value being within a threshold of the second value of the reference parameter: rendering the identified one of the second data items within the featured display area on the hardware display at the first display size and with description text describing the first level of detail; and rendering the first data item outside of the featured display area at the second display size and with description text describing the second level of detail based on the property value of the first data item being outside the threshold of the second value of the reference parameter, the second display size smaller than the first display size, and the second level of detail displaying less detail than the first level of detail.

In Example 11, the subject matter of Example 10 includes, wherein selecting the one or more second data items comprises selecting all of the plurality of data items having respective property values within a second threshold of the first value of the reference parameter.

In Example 12, the subject matter of Examples 10-11 includes, wherein selecting the one or more second data items comprises selecting a pre-specified number of the plurality of data items, the pre-specified number of the plurality of data items having respective property values closest to the first value of the reference parameter.

In Example 13, the subject matter of Examples 10-12 includes, rendering a docked item of the plurality of data items outside of the featured display area, wherein the docked item has a respective property value within a threshold of a third value of the reference parameter, and wherein a display size and description text of the docked item does not change in response to receiving the scroll input.

In Example 14, the subject matter of Examples 10-13 includes, wherein rendering the first data item further comprises rendering an input selectable to perform an action associated with the first data item.

In Example 15, the subject matter of Examples 10-14 includes, wherein the one or more of second data items are grouped into a plurality of secondary display areas outside of the featured display area, and wherein each of the plurality of secondary display areas are defined to display data items for a respective range of values of the reference parameter, and wherein each of the one or more second data items within a respective group are displayed at a same display size.

In Example 16, the subject matter of Examples 10-15 includes, wherein the rendering the first data item in response to receiving the scroll input comprises rendering a scroll animation of the first data item from within the featured display area to outside the featured display area.

In Example 17, the subject matter of Examples 10-16 includes, wherein the first level of detail is displayed values for a first number of a plurality of properties of a respective data item, and wherein the second level of detail is displayed values for a second number of the plurality of properties of a respective one of the plurality of data items, the first number greater than the second number.

In Example 18, the subject matter of Examples 10-17 includes, wherein the first level of detail is full displayed values for one or more properties of a respective data item, and wherein the second level of data is abbreviated displayed values for the one or more properties of a respective data item, the abbreviated displayed values having less text than the full displayed values.

Example 19 is a computing device for scrolling a plurality of data items in a graphical user interface for efficient use of a display area of a hardware display, the computing device comprising: one or more hardware processors: a memory, storing instructions, which when executed, cause the one or more hardware processors to perform operations comprising: defining a featured display area for the graphical user interface, the featured display area defined for display of ones of the plurality of data items based on a reference parameter, the reference parameter identifying a property value of interest for the plurality of data items: identifying a first data item of the plurality of data items for display in the featured display area, the first data item comprising a property value describing a property of the first data item, wherein the first data item is identified based on the property value being within a threshold of a first value of the reference parameter; rendering the first data item within the featured display area on the hardware display, the first data item rendered with a first display size and description text describing a first level of detail describing the first data item: selecting one or more second data items of the plurality of data items for display outside of the featured display area: rendering the one or more second data items outside of the featured display area on the hardware display, each of the one or more second data items rendered with respective second display sizes and description text describing a second level of detail for the respective second data items, each of the respective second display sizes smaller than the first display size, and the first level of detail displaying greater detail than the second level of detail: receiving a scroll input that changes a value of the reference parameter from the first value to a second value: in response to receiving the scroll input: identifying one of the second data items for display in the featured display area, the one of the second data items comprising a property value describing a property of the one of the second data items, wherein the one of the second data items is identified based on the property value being within a threshold of the second value of the reference parameter: rendering the identified one of the second data items within the featured display area on the hardware display at the first display size and with description text describing the first level of detail; and rendering the first data item outside of the featured display area at the second display size and with description text describing the second level of detail based on the property value of the first data item being outside the threshold of the second value of the reference parameter, the second display size smaller than the first display size, and the second level of detail displaying less detail than the first level of detail.

In Example 20, the subject matter of Example 19 includes, wherein the operations of selecting the one or more second data items comprises selecting all of the plurality of data items having respective property values within a second threshold of the first value of the reference parameter.

In Example 21, the subject matter of Examples 19-20 includes, wherein the operations of selecting the one or more second data items comprises selecting a pre-specified number of the plurality of data items, the pre-specified number of the plurality of data items having respective property values closest to the first value of the reference parameter.

In Example 22, the subject matter of Examples 19-21 includes, wherein the operations further comprise: rendering a docked item of the plurality of data items outside of the featured display area, wherein the docked item has a respective property value within a threshold of a third value of the reference parameter, and wherein a display size and description text of the docked item does not change in response to receiving the scroll input.

In Example 23, the subject matter of Examples 19-22 includes, wherein the operations of rendering the first data item further comprises rendering an input selectable to perform an action associated with the first data item.

In Example 24, the subject matter of Examples 19-23 includes, wherein the one or more of second data items are grouped into a plurality of secondary display areas outside of the featured display area, and wherein each of the plurality of secondary display areas are defined to display data items for a respective range of values of the reference parameter, and wherein each of the one or more second data items within a respective group are displayed at a same display size.

In Example 25, the subject matter of Examples 19-24 includes, wherein the operations of rendering the first data item in response to receiving the scroll input comprises rendering a scroll animation of the first data item from within the featured display area to outside the featured display area.

In Example 26, the subject matter of Examples 19-25 includes, wherein the first level of detail is displayed values for a first number of a plurality of properties of a respective data item, and wherein the second level of detail is displayed values for a second number of the plurality of properties of a respective one of the plurality of data items, the first number greater than the second number.

In Example 27, the subject matter of Examples 19-26 includes, wherein the first level of detail is full displayed values for one or more properties of a respective data item, and wherein the second level of data is abbreviated displayed values for the one or more properties of a respective data item, the abbreviated displayed values having less text than the full displayed values.

Example 28 is a computer-implemented method of enabling navigation of a plurality of data items, the method comprising: grouping the plurality of data items into a plurality of groups, each data item having a value of a reference parameter and each group of data items comprising data items within a different, non-overlapping range of reference parameter values: defining a focal display area and a plurality of subsidiary display areas within a graphical user interface, the focal display area being configured to display data items from a selected group and having a primary display area having an first set of display parameters and secondary display area having a second set of display parameters, wherein the first set of display parameters is different from the second set of display parameters, and the subsidiary display areas each being configured to display data items from a different, non-selected group and each subsidiary display area having an associated set of display parameters different from the first set of display parameters: selecting a group of data items having a range of reference parameter values closest to a focal value: sub-dividing the selected group of data items into a plurality of sub-groups, each sub-group comprising data items having a smaller range of reference parameters than the selected group: rendering a sub-group that is closest to the focal value in the primary area, rendering other sub-groups in the one or more secondary areas of the focal display area and rendering a different non-selected group of data items in each of the subsidiary display areas, wherein each data item is rendered according to the set of display parameters for the area in which is rendered: in response to receiving a scroll input from a user: updating the focal value based on a magnitude of the received scroll input: in response to the updated focal value being outside of the range of the selected group, selecting a new group of data items based on the updated focal value, sub-dividing the newly selected group of data items into a plurality of sub-groups, rendering a sub-group that is closest to the focal value in the primary area, rendering other sub-groups in the one or more secondary areas of the focal display area and rendering a different non-selected group of data items in each of the subsidiary display areas; and in response to the updated focal value being inside the range of the selected group, rendering a sub-group that is closest to the updated focal value in the primary area, rendering other sub-groups in the one or more secondary areas of the focal display area and leaving the rendering of the non-selected groups of data items unchanged.

In Example 29, the subject matter of Example 28 includes that the first set of display parameters defines a first display size and a first level of detail and the second set of display parameters defines a second display size and a second level of detail, wherein the first display size is larger than the second display size and the first level of detail is more detailed than the second level of detail.

In Example 30, the subject matter of Examples 28-29 includes that the sets of display parameters associated with the subsidiary display areas may each define a display size that is smaller than the first size and a level of detail that is less detailed than the first level of detail.

In Example 31, the subject matter of Examples 28-30 includes that the first set of display parameters includes parameters for rendering one or more input controls associated with a data item.

In Example 32, the subject matter of Examples 28-31 includes, after updating the focal value: in response to the updated focal value being separated by more than a threshold value from a baseline value: defining a docked display area within the graphical user interface; and rendering a data item having a reference parameter that is closest to the baseline value in the docked display area.

In Example 33, the subject matter of Examples 28-32 includes that each group of data items has the same size of range of reference parameter values.

In Example 34, the subject matter of Examples 28-32 includes that the sizes of the ranges of reference parameter values used to group data items differ between groups of data items.

In Example 35, the subject matter of Examples 28-32 and 34 includes that at least one of the ranges of reference parameter values used to group data items is defined relative to the baseline value.

In Example 36, the subject matter of Examples 28-35 includes that at least one of the ranges of reference parameter values used to group data items is defined in absolute terms.

In Example 37, the subject matter of Examples 28-36 includes that updating the focal value based on a magnitude of the received scroll input comprises: updating the focal value based on a magnitude of the received scroll input and on a difference between the focal value and a baseline value.

In Example 38, the subject matter of Example 37 includes that there is a non-linear relationship between a change to the focal value and the difference between the focal value and a baseline value

In Example 39, the subject matter of Example 38 includes that a scroll input of a detected magnitude results in a smaller change to the focal value if the focal value is closer to the baseline value than if the focal value of the reference parameter is further from the baseline value.

Example 40 is a computer-implemented method of enabling navigation of a plurality of data items, the method comprising: grouping the plurality of data items into a plurality of groups, each data item having a value of a reference parameter and each group of data items comprising data items within a different, non-overlapping range of reference parameter values: defining a focal display area and a plurality of subsidiary display areas within a graphical user interface, the focal display area being configured to display data items from a selected group and having a first set of display parameters and the subsidiary display areas each being configured to display data items from a different, non-selected group and each subsidiary display area having an associated set of display parameters different from the first set of display parameters: selecting a group of data items having a range of reference parameter values closest to a focal value: rendering the selected group of data items in the focal display area and rendering a different non-selected group of data items in each of the subsidiary display areas, wherein each data item is rendered according to the set of display parameters for the area in which is rendered; in response to receiving a scroll input from a user: updating the focal value based on a magnitude of the received scroll input; in response to the updated focal value being outside of the range of the selected group, selecting a new group of data items based on the updated focal value, rendering the selected group of data items in the focal display area and rendering a different non-selected group of data items in each of the subsidiary display areas; and in response to the updated focal value being separated by more than a threshold value from a baseline value: defining a docked display area within the graphical user interface; and rendering a data item having a reference parameter that is closest to the baseline value in the docked display area.

In Example 41, the subject matter of Example 40 includes that the first set of display parameters defines a first display size and a first level of detail and the sets of display parameters associated with the subsidiary display areas each define a display size that is smaller than the first size and a level of detail that is less detailed than the first level of detail.

In Example 42, the subject matter of Examples 40-41 includes that each group of data items has the same size of range of reference parameter values.

In Example 43, the subject matter of Examples 40-41 includes that the sizes of the ranges of reference parameter values used to group data items differ between groups of data items.

In Example 44, the subject matter of Examples 40-41 and 43 includes that at least one of the ranges of reference parameter values used to group data items is defined relative to the baseline value.

In Example 45, the subject matter of Examples 40-44 includes that at least one of the ranges of reference parameter values used to group data items is defined in absolute terms.

In Example 46, the subject matter of Examples 40-45 includes that updating the focal value based on a magnitude of the received scroll input comprises: updating the focal value based on a magnitude of the received scroll input and on a difference between the focal value and a baseline value.

In Example 47, the subject matter of Example 46 includes that there is a non-linear relationship between a change to the focal value and the difference between the focal value and a baseline value

In Example 48, the subject matter of Example 47 includes that a scroll input of a detected magnitude results in a smaller change to the focal value if the focal value is closer to the baseline value than if the focal value of the reference parameter is further from the baseline value.

Example 49 is a system comprising one or more hardware processors and memory arranged to store computer executable instructions that, when executed by the one or more hardware processors, cause the system to perform the method of any of Examples 28-48.

Example 50 is at least one machine-readable medium including instructions that, when executed by processing circuitry, cause the processing circuitry to perform operations to implement of any of Examples 1-48.

The above description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described.

However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

1. A computer-implemented method of enabling navigation of a plurality of data items, the method comprising:
grouping the plurality of data items into a plurality of groups, each data item having a value of a reference parameter and each group of data items comprising data items within a different, non-overlapping range of reference parameter values;
defining a focal display area and a plurality of subsidiary display areas within a graphical user interface, the focal display area being configured to display data items from a selected group and having a primary display area having a first set of display parameters and secondary display area having a second set of display parameters, wherein the first set of display parameters is different from the second set of display parameters, and the subsidiary display areas each being configured to display data items from a different, non-selected group and each subsidiary display area having an associated set of display parameters different from the first set of display parameters;
selecting a group of data items having a range of reference parameter values closest to a focal value;
sub-dividing the selected group of data items into a plurality of sub-groups, each sub-group comprising data items having a smaller range of reference parameters than the selected group;
rendering a sub-group that is closest to the focal value in the primary area, rendering other sub-groups in the one or more secondary areas of the focal display area and rendering a different non-selected group of data items in each of the subsidiary display areas, wherein each data item is rendered according to the set of display parameters for the area in which is rendered; and
in response to receiving a scroll input from a user:
updating the focal value based on a magnitude of the received scroll input;
in response to the updated focal value being outside of the range of the selected group, selecting a new group of data items based on the updated focal value, sub-dividing the newly selected group of data items into a plurality of sub-groups, rendering a sub-group that is closest to the focal value in the primary area, rendering other sub-groups in the one or more secondary areas of the focal display area and rendering a different non-selected group of data items in each of the subsidiary display areas; and
in response to the updated focal value being inside the range of the selected group, rendering a sub-group that is closest to the updated focal value in the primary area, rendering other sub-groups in the one or more secondary areas of the focal display area and leaving the rendering of the non-selected groups of data items unchanged.

2. The method according to claim 1, wherein the first set of display parameters defines a first display size and a first level of detail and the second set of display parameters defines a second display size and a second level of detail, wherein the first display size is larger than the second display size and the first level of detail is more detailed than the second level of detail.

3. The method according to claim 2, wherein the sets of display parameters associated with the subsidiary display areas each define a display size that is smaller than the first size and a level of detail that is less detailed than the first level of detail.

4. The method according to claim 2, wherein the first set of display parameters includes parameters for rendering one or more input controls associated with a data item.

5. The method according to claim 1, further comprising, after updating the focal value:
in response to the updated focal value being separated by more than a threshold value from a baseline value:
defining a docked display area within the graphical user interface; and
rendering a data item having a reference parameter that is closest to the baseline value in the docked display area.

6. The method according claim 1, wherein each group of data items has the same size of range of reference parameter values.

7. The method according to claim 1, wherein the sizes of the ranges of reference parameter values used to group data items differ between groups of data items.

8. The method according to claim 1, wherein at least one of the ranges of reference parameter values used to group data items is defined relative to the baseline value.

9. The method according to claim 1, wherein at least one of the ranges of reference parameter values used to group data items is defined in absolute terms.

10. The method according to claim 1, wherein updating the focal value based on a magnitude of the received scroll input comprises:
updating the focal value based on a magnitude of the received scroll input and on a difference between the focal value and a baseline value.

11. The method according to claim 10, wherein there is a non-linear relationship between a change to the focal value and the difference between the focal value and a baseline value.

12. The method according to claim 11, wherein a scroll input of a detected magnitude results in a smaller change to the focal value if the focal value is closer to the baseline value than if the focal value of the reference parameter is further from the baseline value.

13. A computer-implemented method of enabling navigation of a plurality of data items, the method comprising:
grouping the plurality of data items into a plurality of groups, each data item having a value of a reference parameter and each group of data items comprising data items within a different, non-overlapping range of reference parameter values;
defining a focal display area and a plurality of subsidiary display areas within a graphical user interface, the focal display area being configured to display data items from a selected group and having a first set of display parameters and the subsidiary display areas each being configured to display data items from a different, non-selected group and each subsidiary display area having an associated set of display parameters different from the first set of display parameters;
selecting a group of data items having a range of reference parameter values closest to a focal value;
rendering the selected group of data items in the focal display area and rendering a different non-selected group of data items in each of the subsidiary display areas, wherein each data item is rendered according to the set of display parameters for the area in which is rendered;
in response to receiving a scroll input from a user:
updating the focal value based on a magnitude of the received scroll input;
in response to the updated focal value being outside of the range of the selected group, selecting a new group of data items based on the updated focal value, rendering the selected group of data items in the focal display area and rendering a different non-selected group of data items in each of the subsidiary display areas; and
in response to the updated focal value being separated by more than a threshold value from a baseline value: defining a docked display area within the graphical user interface; and rendering a data item having a reference parameter that is closest to the baseline value in the docked display area.

14. A system comprising one or more hardware processors and memory arranged to store computer executable instructions that, when executed by the one or more hardware processors, cause the system to perform the method of claim 13.

15. Computer readable medium comprising computer executable instructions that, when executed, cause the computer to perform the method of claim 13.
